(19) United States
(12) Patent Application Publication
(10) Pub. No.: US 2013/0309147 A1
(43) Pub. Date: Nov. 21, 2013

(54) SAMPLE TUBE WITH IMPROVED SEAL

(71) Applicant: Gene Era Biotech Co. Ltd., (US)

(72) Inventor: Weiming Yu, Hangzhou (CN)

(73) Assignee: GENE ERA BIOTECH CO. LTD., Hangzhou (CN)

(21) Appl. No.: 13/832,010

(22) Filed: Mar. 15, 2013

Related U.S. Application Data
(63) Continuation of application No. PCT/CN2012/079501, filed on Aug. 1, 2012.

(30) Foreign Application Priority Data
May 16, 2012 (CN) 201210154021.X

(51) Int. Cl. B01L 3/00

(52) U.S. Cl. CPC B01L 3/50825
USPC 422/550

(57) ABSTRACT

The present invention provides sample tube assemblies with improved seal.

### CROSS REFERENCE TO RELATED APPLICATION

This is a continuation application of PCT/CN2012/079501 filed on Aug. 1, 2012, which claims the priority of the Chinese Application No. 201210154021.X filed on May 16, 2012, the entire content of which is hereby incorporated herein by reference.

### FIELD OF THE INVENTION

The present invention generally relates to sample tubes for handling liquid reagents, and particularly to sample tubes with improved seal and especially suitable for thermocycling reactions, sample preparation and storage.

### BACKGROUND OF THE INVENTION

Molecular biology experiments are conducted at ever increasing throughputs in low reaction volumes and often require high temperature conditions. Frequently, biological samples to be analyzed are only available in small quantities. Moreover, the need for reducing reagent costs especially in commercial settings demands minimization of reaction volumes. When heated, e.g., in PCR experiments, low volume reactions are particularly sensitive to loss of liquid. Therefore, improved seal in sample tubes will result in increased consistency in experiments with low reaction volumes and lead to costing saving.

### SUMMARY OF THE INVENTION

The present invention provides sample tube assemblies with improved seal. Using such sample tube assemblies in PCR reactions effectively prevents leaks and reduces loss of reaction volume.

Accordingly, in a first aspect, the present invention provides a sample tube assembly which comprises a hollow vessel body having a substantially cylindrical upper wall section defining at its edge portion the opening of the vessel body. The sample tube assembly also has a sealing cap comprising a substantially cylindrically shaped member which is removably insertable through the opening of the vessel body into the vessel body and engages the upper wall section to hermetically seal the vessel body. Additionally, the substantially cylindrically shaped member includes at least two cylindrical layers having different hardness properties: a sealing layer and a supporting layer, around the axis of the cylindrically shaped member. The sealing layer is elastic and flexible while the supporting layer is relatively hard and rigid. Generally, the supporting layer has a greater hardness (as measured according to ASTM test D 2240) than the sealing layer. Preferably, the sealing layer and the supporting layer are coaxial and concentric. Also preferably, the two layers are permanently joined together. The substantially cylindrically shaped member may be a substantially cylindrical skirt, or alternatively, a substantially cylindrical rod with a filled core. The sealing layer may be coextensive with and covers the entire surface of the supporting layer, or alternatively an annular ring covering a portion of the supporting layer, but around the entire circumference of the portion. In yet another alternative, the sealing layer is a continuous layer around the entire circumference of a portion of the substantially cylindrically shaped member, while the supporting layer comprises two, three, four, five, or eight or more elongated strips or sections circumferentially spaced apart either on the sealing layer or embedded within the sealing layer, each extending axially along the portion of the substantially cylindrically shaped member. Preferably the sealing layer is directly molded onto the supporting layer. Preferably, when the sealing cap is removably inserted through the opening of the vessel body into the vessel body, the sealing layer, but not the supporting layer, engages the upper wall section of the vessel body to hermetically seal the vessel body.

In one embodiment, the sealing layer is on an outer peripheral surface of the substantially cylindrically shaped member around its entire circumference, and when the sealing cap is inserted into the vessel body, the sealing layer is in sealing contact with an inside peripheral surface of the upper wall section of the vessel body. In another embodiment, the substantially cylindrically shaped member is in a form of a cylindrical skirt and the sealing layer is on an inner peripheral surface of the cylindrical skirt around its entire circumference, and when the sealing cap seals the vessel body the sealing layer engages and is in sealing contact with an outside peripheral surface of the upper wall section.

In accordance with another aspect, a sample tube assembly is provided which includes a hollow vessel body and a sealing cap. The sealing cap may be separate and detached from the vessel body, or may be connected to the vessel body through a flexible tether. The vessel body includes a substantially cylindrical upper wall section having at least two cylindrical layers having different hardness properties, around the axis of the cylindrical upper wall section, i.e., the axis of the vessel body. The two layers are a sealing layer and a supporting layer. Preferably, the two layers are permanently joined. Also preferably, the two layers are concentric and coaxial. The sealing layer may be coextensive with and cover the entire surface of the supporting layer in the upper wall section, or alternatively may be an annular ring covering a portion of the supporting layer, but around the entire circumference of the portion. In yet another alternative, the sealing layer is a continuous layer around the entire circumference of a portion of the upper wall section, while the supporting layer comprises two, three, four, five, or eight or more elongated strips or sections circumferentially spaced apart either on the sealing layer or embedded within the sealing layer, each extending axially along the portion of the upper wall section. The sealing layer should be elastic and flexible while the supporting layer is relatively hard and rigid. Generally, the supporting layer has a greater hardness (as measured according to ASTM test D 2240) than the sealing layer. The sealing cap includes a substantially cylindrically shaped member which may be in engagement with the sealing layer of the upper wall section to hermetically seal the vessel. Preferably the sealing layer is directly molded onto the supporting layer. Preferably, when the sealing cap is removably inserted through the opening of the vessel body into the vessel body, the sealing layer, but not the supporting layer, engages the substantially cylindrically shaped member of the sealing cap.

In one embodiment, the sealing layer is on an inside peripheral surface of the upper wall section, preferably around its entire circumference, whereby when the cylindrically shaped member inserts into the vessel body through the opening of the vessel body of the sample tube the sealing layer is in engagement and sealing contact with an outer peripheral surface of the substantially cylindrically shaped member. In this embodiment, the cylindrically shaped member may be a substantially cylindrical skirt, or alternatively, a rod with a filled core.

In another embodiment, the sealing layer is on an outside peripheral surface of the upper wall section around its entire circumference, and the substantially cylindrically shaped member is a substantially cylindrical skirt having an inner peripheral surface engaging and in sealing contact with the sealing layer on the outside peripheral surface of the upper wall section of the vessel body.

In accordance with another aspect, the sample tube assembly as described in the above aspects further comprises a flexible strap having opposite ends that are respectively connected with the vessel body and the sealing cap. In yet another aspect, the sample tube is adapted into a sample tube strip, in which a plurality of the hollow vessel bodies described above is arranged symmetrically in a linear array whereby their axes are in parallel. The sample tube strip further includes a linear array of a plurality of the above-provided sealing caps and any two adjacent sealing caps are connected by a tether.

In yet another aspect, the sample tubes are adapted into a multiwell plate, e.g., a multiwell microtiter plate, in which a plurality of the hollow vessel bodies described above is arranged symmetrically into a microtiter plate whereby their axes are in parallel. Preferably, the multiwell plate further includes a plurality of the above-provided sealing caps and any two adjacent sealing caps are connected by a tether or a sheet. Thus, for example, a multiwell plate assembly may comprise a plate body having therein a plurality of wells (e.g., 36, 48, 96, 192 or 364) each having an opening, a closed bottom, and a side wall extending therebetween. At least one of the wells has a substantially cylindrical upper wall section defining at its edge portion the opening. The assembly may also include a plurality of sealing caps at least one of which having a substantially cylindrically shaped member comprising at least a sealing layer and a supporting layer permanently joined together. The supporting layer should have a greater hardness, as measured according to ASTM test D 2240, than the sealing layer, and the sealing layer engages and is in sealing contact with the upper wall section of the well. In some embodiments, the sealing layer is on an outer peripheral surface of the substantially cylindrically shaped member, and is in sealing contact with an inside peripheral surface of the upper wall section. In other embodiments, the substantially cylindrically shaped member is skirt-like, and the sealing layer is on an inner peripheral surface of the substantially cylindrically shaped member, and is in sealing contact with an outside peripheral surface of the upper wall section.

In another aspect, a multiwell plate assembly is provided including a plate body having therein a plurality of wells (e.g., 36, 48, 96, 192 or 364) each having an opening, a closed bottom, and a side wall extending therebetween, wherein at least one of the wells has a substantially cylindrical upper wall section defining at its edge portion the opening. The upper wall section has at least a sealing layer and a supporting layer permanently joined together, and the supporting layer has a greater hardness, as measured according to ASTM test D 2240, than the sealing layer. The assembly may also include a plurality of sealing caps each comprising a substantially cylindrically shaped member, at least one of which is in sealing contact with the sealing layer of the upper wall section. In some embodiments, the sealing layer is on an outer peripheral surface of the upper wall section. In other embodiments, the sealing layer is on an inner peripheral surface of the upper wall section.

In the various aspects and the embodiments thereof, the sealing layer may have a compression factor of from about 1.5:1 to about 3:1, or a compression set of less than about 30%, preferably less than 20%, more preferably less than 10%, and most preferably less than 5%, as measured according to ASTM D395 Method B. The sealing layer may have a hardness of from about 30 to about 90 Shore A, preferably about 35 to about 80 Shore A, about 40 to about 80 Shore A, about 40 to about 70 Shore A, more preferably about 40 to about 50 or 60 Shore A, as measured by ASTM test D 2240. For example, the sealing layer may be made of one or more polymer materials chosen from the group consisting of polyethylene (PE) (especially low density polyethylene or LDPE), polyurethane (PU), thermoplastic polyurethanes (TPU), thermoplastic elastomers (TPE), thermoplastic polyolefin (TPO), styrenic thermoplastic elastomers (S-TPEs), thermoplastic rubber (TPR), poly[styrene-b-(ethylene-co-butylene)-b-styrene] (SEBS), thermoplastic vulcanizates (TPV), styrene-butadiene-styrene (SBS), flexible PVC (e1PVC), etc.

In the various aspects and the embodiments thereof, the supporting layer may have a hardness of greater than about 30 Shore D, as measured by ASTM test D 2240. In some embodiments, the supporting layer has a hardness of from about 30 to about 90 Shore D, as measured by ASTM test D 2240. Examples of polymer materials for forming the supporting layer include, but are not limited to, polypropylene (PP), polycarbonate (PC), polyvinyl chloride (PVC), acrylonitrile butadiene styrene (ABS), and polystyrene (PS).

In preferred embodiments, the supporting layer has a hardness (ASTM test D 2240) of at least 5, preferably at least 10 Shore A greater than the sealing layer.

In preferred embodiments, the sample tube has a total volume of from about 0.1 ml to about 2.0 ml. In preferred embodiments, all materials used for the sample tube assembly are heat stable and can withstand heat at a temperature of up to 100° C.

Also, in the various aspects and the embodiments thereof, the sealing layer forms an annular region that extends axially, and preferably continuously, along at least 10%, 20%, 30%, 40%, 50%, 60%, 70% or at least 80% of the entire length of the upper wall section of the vessel body or of the substantially cylindrically shaped member of the sealing cap. Preferably, the sealing layer is coextensive with and covers the entire surface of the upper wall section of the vessel body or of the substantially cylindrically shaped member of the sealing cap. Alternatively, the sealing layer may be in a form of an annular convexity covering a portion of the supporting layer but around the entire circumference of the portion, preferably at the lower edge portion of the cylindrically shaped member, or at the upper edge portion of the upper wall section. In some embodiments, there may be two or more coaxial annular rings (e.g., an O-ring) spaced axially apart.

The foregoing and other advantages and features of the invention, and the manner in which the same are accomplished, will become more readily apparent upon consideration of the following detailed description of the invention taken in conjunction with the accompanying examples, which illustrate preferred and exemplary embodiments.

### BRIEF DESCRIPTION OF THE DRAWINGS

FIG. 1A is a sectional view of one preferred embodiment of a sample tube assembly;

FIG. 1B is a sectional view of an upper part of the sample tube assembly in FIG. 1A when the sealing cap is inserted into the vessel body;

FIG. 1C is sectional view of an enlarged portion of the upper part shown in FIG. 1B;

FIG. 2A is sectional view of another preferred embodiment of a sample tube assembly; FIG. 2B shows the sample tube assembly in FIG. 2A in a closed position; FIG. 2C shows a portion of FIG. 2B illustrating the details of FIGS. 2A and 2B;

FIG. 3A is a sectional view of yet another preferred embodiment of a sample tube assembly;

FIG. 3B is a sectional view of an alternative embodiment of the sealing cap in FIG. 3A;

FIG. 3C is a sectional view of the sample tube of FIG. 3A with the sealing cap engaging the vessel body closing the sample tube;

FIG. 3D is an expanded view of the top portion of FIG. 3C;

FIG. 4 is a sectional view of a preferred embodiment of a sample tube assembly;

FIG. 5 is a sectional view of an embodiment of a sample tube assembly;

FIG. 5A is a sectional view of the sample tube assembly in FIG. 5 in closed position;

FIG. 6 is a sectional view of another embodiment of a sample tube assembly;

FIG. 6A is a perspective view of the vessel body of the sample tube assembly of FIG. 6;

FIG. 6B is a sectional view of the sample tube assembly in FIG. 6 in closed position;

FIG. 7A is a horizontal cross-sectional view of a bilayer construction;

FIG. 7B is a horizontal cross-sectional view of a bilayer construction;

FIG. 7C is a horizontal cross-sectional view of a bilayer construction;

FIG. 7D is a horizontal cross-sectional view of a bilayer construction;

FIG. 8 is a sectional view of a sample tube strip;

FIG. 8A is an expanded view of the Section A in FIG. 8;

FIG. 8B is a sectional view of the sample tube strip in FIG. 8 sealed with sealing caps;

FIG. 8C is an expanded view of the Section B in FIG. 8B;

FIG. 8D is a prospective view of a multiwell plate assembly; and

FIG. 8E is an expanded view of the Section C in FIG. 8D.

### DETAILED DESCRIPTION OF THE INVENTION

Accordingly, the present invention provides a sample tube assembly with improved seal, which results in part from the incorporation in the cap or the hollow vessel body a special sealing layer.

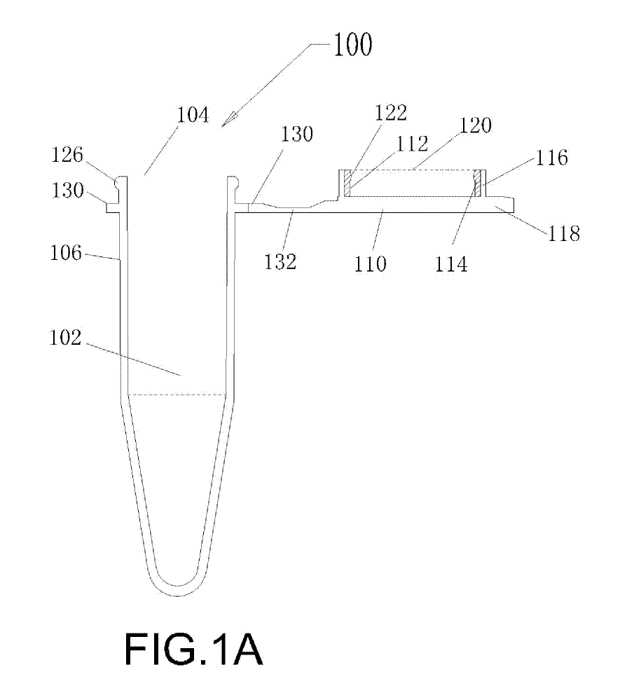

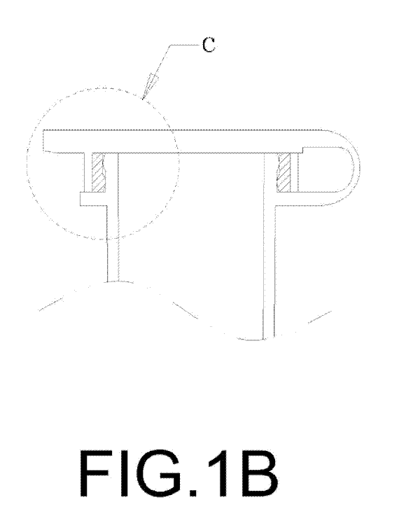

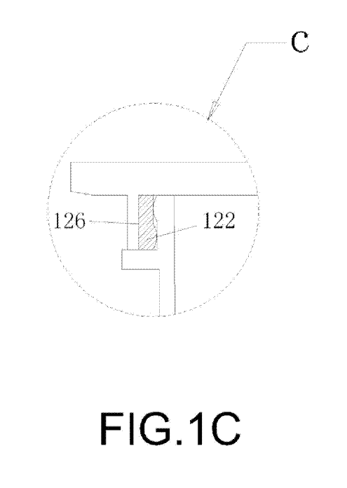

Referring to FIG. 1A, an illustrative embodiment of the present invention is shown. Sample tube assembly 100 includes a hollow vessel body 102 for containing either solid or liquid reagents. Vessel body 102 has a closed bottom and at its top an opening 104, which is defined by a substantially cylindrical upper wall section 106. Sample tube assembly 100 also includes a sealing cap 110, which may be separate and detached from vessel body 102, or optionally may be connected to the vessel body 102 through a tether that is preferably flexible.

Sealing cap 110 includes a cylindrical skirt 112 having two concentric layers: an inner sealing layer 114 and an outer supporting layer 116. At the upper rim of cylindrical skirt 112 is a transverse wall 118. The cylindrical skirt 112 has an opening 120 large enough for the upper wall section 106 in the vessel body 102 to be inserted into it at opening 104. As such, sealing cap 110 snug fits upper wall section 106 such that sealing layer 114 is in sealing contact with the outside peripheral surface of upper wall section 106 to provide a tight seal, and preferably fluid-tight seal, as shown in FIG. 1B.

In preferred embodiments, sealing layer 114 of cylindrical skirt 112 has an inwardly protruding sealing lip 122 at the lower edge of cylindrical skirt 112. Sealing lip 122 is essentially a peripheral, annular ridge of a certain inwardly axial extension at the lower edge of sealing layer 114. Also in preferred embodiments, the upper wall section 106 has a flange 126 at the edge portion of opening 104. Flange 126 is a peripheral annular convexity of a certain outwardly axial extension. Both sealing lip 122 and flange 126 are adapted to allow the sealing cap snug fits upper wall section of the vessel body, and contribute to a fluid-tight seal, as shown in FIG. 1C.

Optionally, as shown in FIG. 1A, upper wall section 106 also includes an external shoulder 130 near the edge portion of opening 104, and around the entire circumference of the upper wall section 106. External shoulder 130 may be in any shape, e.g., flat or conically beveled, so long as it engages the lower end of cylindrical skirt 112 of the sealing cap to provide some support for the sealing cap and prevent excess insertion of upper wall section 106 into the cylindrical skirt 112, as is shown in FIGS. 1B & 1C. In one embodiment, external shoulder 130 is connected to sealing cap 110 through a tether 132.

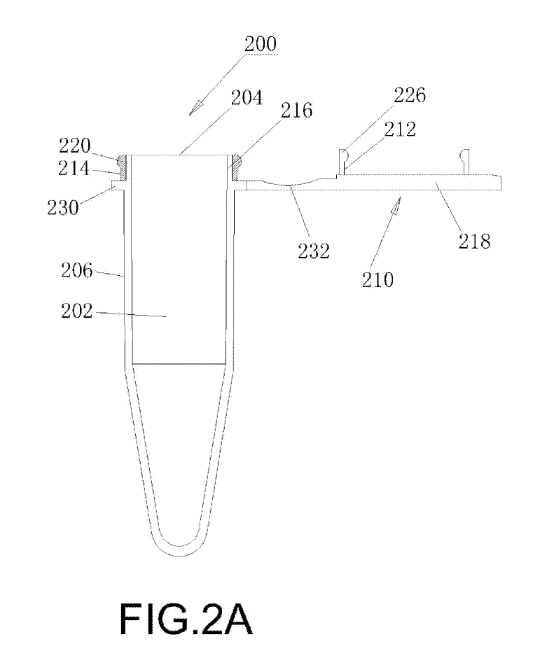

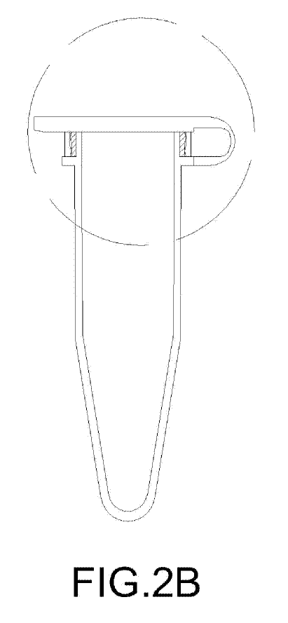

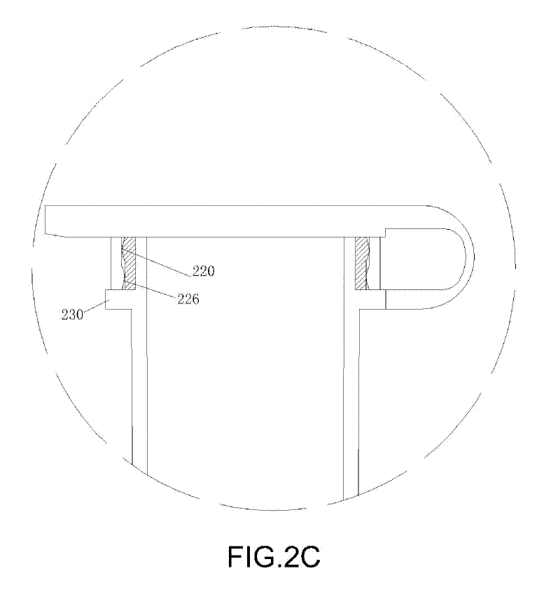

FIG. 2A is an alternative embodiment that is similar to that shown in FIG. 1. However, in contrast to that shown in FIG. 1, the sealing layer in the cylindrical skirt of the sealing cap is moved to the edge portion of the upper wall section of the vessel body. Thus, referring to FIG. 2A, sample tube assembly 200 includes a hollow vessel body 202 with a closed bottom and at its top an opening 204 defined by a substantially cylindrical upper wall section 206. Upper wall section 206 has a first portion near the opening 204. In the first portion, the sidewall includes two concentric layers: an outer sealing layer 214 and an inner supporting layer 216.

Sample tube assembly 200 also includes a sealing cap 210, which may be separate and detached from vessel body 202, or optionally may be connected to the vessel body 202 through a tether that is preferably flexible. Sealing cap 210 includes a cylindrical skirt 212 and at the upper rim of cylindrical skirt 212 a transverse wall 218. The diameter and circumference of the first portion of the substantially cylindrical upper wall section 206 are adapted for removable insertion into cylindrical skirt 212 such that sealing cap 210 snug fits upper wall section 206 such that sealing layer 214 is in sealing contact with the inside peripheral surface of cylindrical skirt 212 of sealing cap 210.

In preferred embodiments, sealing layer 214 has an outwardly protruding sealing lip 220 at the edge portion of opening 204. Sealing lip 220 is essentially a peripheral, annular ridge of a certain outwardly axial extension at the edge portion of sealing layer 214. Also in preferred embodiments, at lower edge of cylindrical skirt 212 of sealing cap 210 is flange 226 which is a peripheral annular convexity of a certain inwardly axial extension. Both sealing lip 220 and flange 226 are adapted to allow the sealing cap snug fits upper wall section of the vessel body, and contribute to a tight seal.

Optionally, as shown in FIG. 2A, upper wall section 206 also includes an external shoulder 230 near the edge portion of opening 204, and around the entire circumference of the upper wall section 206. External shoulder 230 may be in any shape, e.g., flat or conically beveled, so long as it engages the lower end of cylindrical skirt 212 of the sealing cap to provide some support for the sealing cap and prevent excess insertion of upper wall section 206 into the cylindrical skirt 212. In one embodiment, external shoulder 230 is connected to sealing cap 210 through a flexible tether 232.

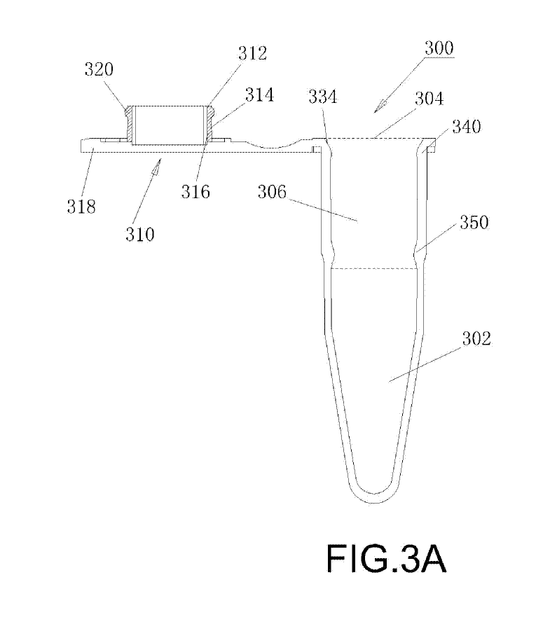

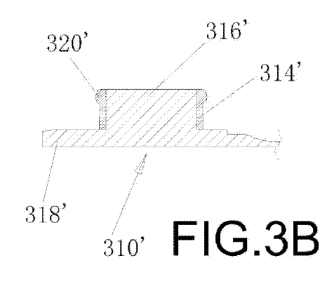

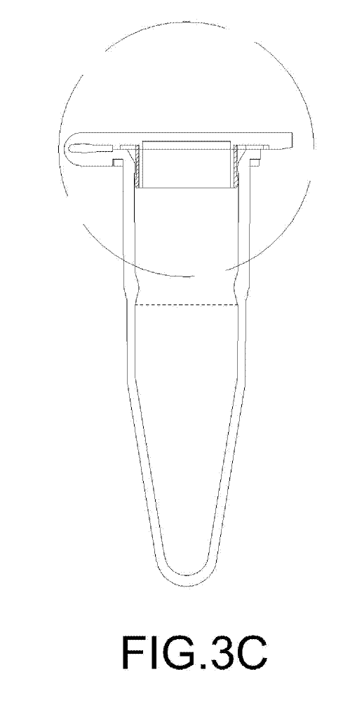

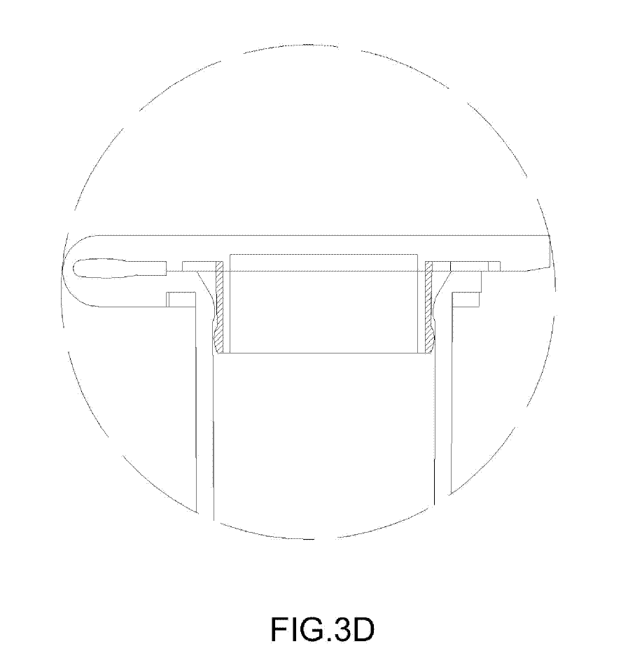

FIG. 3A shows another embodiment of the present invention. Sample tube assembly 300 includes a sealing cap 310, which may be separate and detached from vessel body 302, or optionally may be connected to the vessel body 302 through a tether that is preferably flexible.

Sealing cap 310 includes a substantially cylindrically shaped member for removable insertion into the vessel body 302 through vessel body opening 304, and engages the first upper wall section 306 of the vessel body 302. In one embodiment, as shown in FIG. 3A, the substantially cylindrically shaped member of sealing cap 310 is a cylindrical skirt 312 having two concentric layers: an outer sealing layer 314 and an inner supporting layer 316. At the upper rim of cylindrical skirt 312 is a transverse wall 318 closing off one end of the cylindrical skirt 312. In another embodiment as shown in FIG. 3B, the substantially cylindrically shaped member has a substantially cylindrical solid supporting core 316′, and an outer sealing layer 314′ around the entire circumference of the supporting core 316′. It is noted that while in FIG. 3A and 3B the sealing layers 314 and 314′ are shown to span the entire face of the cylindrically shaped member, they may only cover axially a section of the cylindrical surface of the cylindrically shaped member, but around the entire circumference of the section. For example, the sealing layers may be in a form of an annular convexity around the cylindrically shaped member, e.g., an annular O-ring, on top of the respective supporting layers. In some embodiments, the sealing layer forms an annular region that extends axially, and preferably continuously, along at least 10%, 20%, 30%, 40%, 50%, 60%, 70% or at least 80% of the entire length of the upper wall section. Preferably, the sealing layer comprises one annular ring covering a portion of the supporting layer at the lower edge of lower edge portion of the cylindrically shaped member around the entire circumference of the portion. Regardless, sealing layers 314 and 314′ should be in sealing contact with the inside peripheral surface of the upper wall section 306 to provide fluid-tight seal.

As shown in FIG. 3A & 3B, in preferred embodiments, sealing layer 314 and 314′ have an outwardly protruding annular sealing lip 320 and 320′, respectively, at the lower edge portion of the cylindrically shaped member. Preferably, the sealing lips are an annular flange extending axially and outwardly at the edge portion of the sealing layers and around the entire circumference of the sealing layers.

Referring again to FIG. 3A, the hollow vessel body 302 has with a closed bottom and at its top an opening 304 defined by a substantially cylindrical upper wall section 306. In preferred embodiments, the edge portion of the upper wall section 306 defining the opening 304 has an upwardly flaring, conical inside surface 334 to facilitate the insertion of the sealing cap into the vessel body. In preferred embodiments, upper wall section 306 has a first ridge 340 of a certain inwardly axial extension near the opening 304. Also in preferred embodiments, upper wall section 306 also has, near its lower end, a second ridge 350 of a certain inwardly axial extension, which may provide a certain degree of support for the lower rim of sealing cap 310 or 310′. The first and second ridges independently may be an annular ridge of a certain inwardly axial extension and around the entire circumference of the upper wall section 306, or alternatively, a single piece of inwardly radial protrusion. In particular, it is preferred that the second ridge 350 is an annular ridge and is in sealing contact with and snug fits annular sealing lip 320 or 320′ so as to provide a fluid-tight seal.

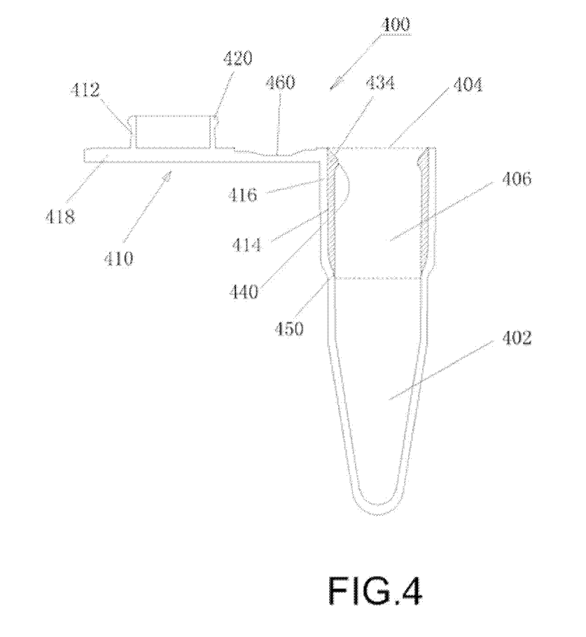

FIG. 4 is an alternative embodiment that is similar to that shown in FIG. 3. However, in contrast to that shown in FIG. 3, the sealing layer in the sealing cap is moved to the inside surface of the upper wall section of the vessel body. Thus, referring to FIG. 4, sample tube assembly 400 includes a hollow vessel body 402 with a closed bottom and at its top an opening 404 defined by a substantially cylindrical upper wall section 406. Upper wall section 406 includes two coaxial or concentric layers: an inner sealing layer 414 and an outer supporting layer 416.

In preferred embodiments, the edge portion of the upper wall section 406 defining the opening 404 has an upwardly flaring, conical inside surface 434 to facilitate the removable insertion of the sealing cap into the vessel body. In preferred embodiments, upper wall section 406 has a first ridge 440 of a certain inwardly axial extension near the opening 404. Also in preferred embodiments, upper wall section 406 also has, near its lower end, a second ridge 450 of a certain inwardly axial extension, which may provide a certain degree of support for the lower rim of sealing cap 410 when the sealing cap is inserted into the vessel body. The first and second ridges independently may be an annular ridge of a certain inwardly axial extension and around the entire circumference of the upper wall section 406, or alternatively, a tooth-like single piece of inwardly radial protrusion. In particular, it is preferred that the second ridge 450 is an annular ridge.

Referring also to FIG. 4, sample tube assembly 400 also includes a sealing cap 410, which may be separate and detached from vessel body 402, or optionally may be connected to the vessel body 402 through a tether 460 that is preferably flexible. Sealing cap 410 includes a substantially cylindrically shaped member for removable insertion into the vessel body 402 through vessel body opening 404, and engages the first upper wall section 406 of the vessel body 402. The substantially cylindrically shaped member may be a cylindrical skirt 412. Alternatively, cylindrically shaped member may be a column with a filled core. At the upper rim of the cylindrically shaped member may be a transverse wall 418, which when the cylindrically shaped member is a cylindrical skirt, closes the upper end of the cylindrical skirt.

In preferred embodiments, the substantially cylindrically shaped member of the sealing cap, e.g., cylindrical skirt 412, has an outwardly protruding sealing lip 420 which is an annular bulge of a certain outwardly axial extension around the entire circumference of the substantially cylindrically shaped member, e.g., cylindrical skirt 412. Preferably, the sealing lip 420 is at the lower edge portion of the substantially cylindrically shaped member, e.g., cylindrical skirt 412, as shown in FIG. 4. The sealing lip is adapted to allow the sealing cap snug fits upper wall section 406 of the vessel body, and preferably is in sealing contact with and snug fits the second ridge 450 of the upper wall section 406 so as to provide a fluid-tight seal.

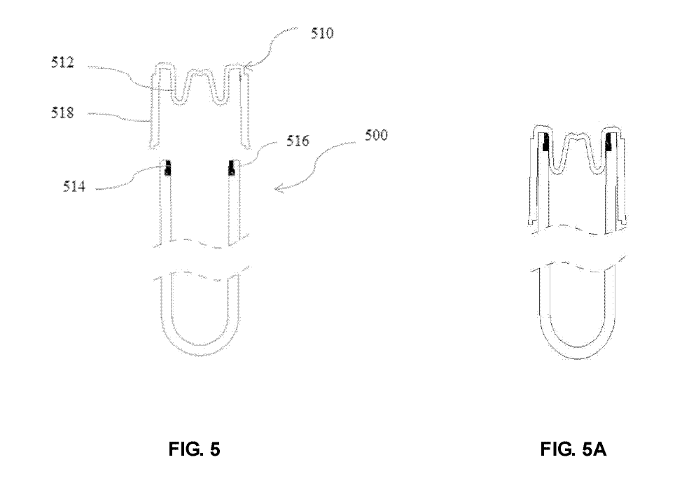

FIG. 5 illustrates a variant of the sample tube assembly of FIG. 4. Specifically, in contrast to the sample tube assembly shown in FIG. 4, the transverse wall 418 in the sealing cap of FIG. 4 becomes a second cylindrical skirt 518 in the sealing cap 510 of sample tube assembly 500 in FIG. 5. As such, when the sealing cap 510 is used to seal the sample tube as shown in FIG. 5A, the outer surface of the substantially cylindrically shaped member 512 is in sealing contact with the sealing layer 514 of the upper section wall, while the inner surface of cylindrical skirt 518 is in contact with the supporting layer 516.

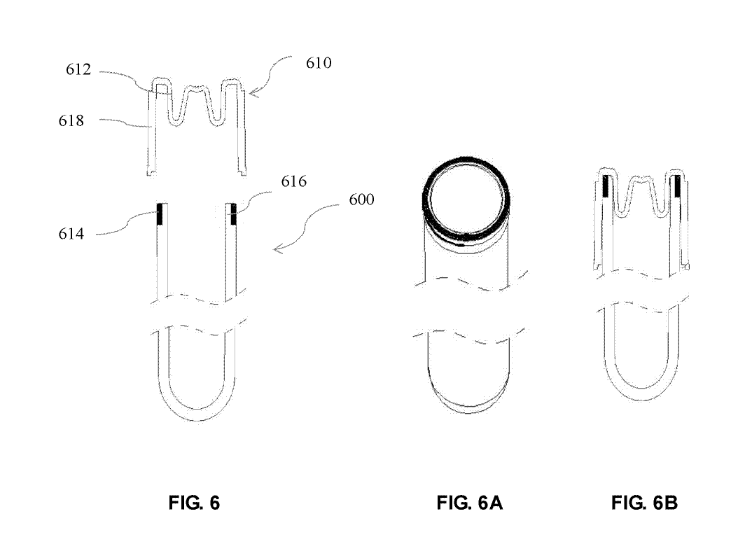

Similarly, FIG. 6 illustrates a variant of the sample tube assembly of FIG. 2A. The sealing cap 610 includes a cylindrical member 612 and a second cylindrical skirt 618. When the sealing cap 610 is used to seal the sample tube as shown in FIG. 6A, the outer surface of the substantially cylindrically shaped member 612 is in contact with the supporting layer 616 of the upper section wall, while the inner surface of cylindrical skirt 618 is in sealing contact with the sealing layer 614.

In any one of the sample tube assemblies illustrated above, the two contacting surfaces (i.e., one on the sealing cap and the other on the upper wall section of the vessel body) may be smooth. Alternatively, however, the two surfaces for sealing contact may be corrugated, having grooves and ridges, and sealing is accomplished by screwing the sealing cap onto the hollow vessel body. FIG. 6A for example is a perspective view of the vessel body in FIG. 6 showing exemplary grooves and ridges in the sealing layer on the outer surface of the upper wall section.

In various embodiments of the sample tube assembly, the vessel body generally has a lower wall section joining the substantially cylindrical upper wall section described above. In some embodiments, the lower wall section may be a thin-walled tapered or conical section with an angle of about 10 to about 20 degrees to form a closed dome-shaped bottom of the vessel body. In preferred embodiments, the sample tube assembly is particularly suited for thermocyling reactions such as PCR, and the walls of the vessel body may have a thickness of from about 0.008 to about 0.015 inches. The lower wall section may be thinner and may have a thickness of from about 0.008 to about 0.012 inches, while the upper wall section may be thicker with a thickness of from about 0.010 to about 0.015 inches. The supporting layer may have a thickness of from about 0.008 to about 0.06 inches.

In preferred embodiments, the sample tube may have a volume sufficient to contain from about 50 μl to less than about 1 ml of liquid, preferably less than about 0.5 ml of liquid.

Generally speaking, in the various aspects of the present invention, the supporting layer has a greater hardness (as measured according to ASTM test D 2240) than the sealing layer. In preferred embodiments, the supporting layer has a hardness (ASTM test D 2240) of at least 5, preferably at least 10 Shore A greater than the sealing layer. Preferably, the supporting layer and the sealing layer have different polymeric compositions.

The sealing layer may have a compression set of less than about 30%, preferably less than 20%, more preferably less than 10%, and most preferably less than 5%, as measured according to ASTM D395 Method B. The sealing layer may have a hardness of from about 30 to about 90 Shore A, preferably about 35 to about 80 Shore A, about 40 to about 75 or 80 Shore A, about 40 to about 70 Shore A, more preferably about 40 to about 50 or 60 Shore A, as measured by ASTM test D 2240. Examples of polymer materials useful for forming the sealing layer include, but are not limited to, polyethylene (PE) (especially low density polyethylene or LDPE), polyurethane (PU), thermoplastic polyurethanes (TPU), thermoplastic elastomers (TPE), thermoplastic polyolefin (TPO), styrenic thermoplastic elastomers (S-TPEs), thermoplastic rubber (TPR), poly[styrene-b-(ethylene-co-butylene)-b-styrene] (SEBS), thermoplastic vulcanizates (TPV), styrene-butadiene-styrene (SBS), flexible PVC (e1PVC), etc. In preferred embodiments, the sealing layer is made of one or more of TPE, TPU and PVC, preferably TPE or TPU or both.

The non-sealing layer parts of the sample tube assembly including the supporting layer are generally intended to be supportive and to maintain the shape and rigidity. In some embodiments, the supporting layer may have a hardness of greater than about 20 Shore D or greater than about 30 Shore D, as measured by ASTM test D 2240. In some embodiments, the supporting layer has a hardness of from about 30 to about 90 Shore D, as measured by ASTM test D 2240. In some embodiments, the supporting layer has a compression set of at least about 20%, or at least 30%. Examples of polymer materials for forming the supporting layer include, but are not limited to, polypropylene (PP), polycarbonate (PC), polyvinyl chloride (PVC), acrylonitrile butadiene styrene (ABS), and polystyrene (PS).

Preferably, the polymer material for the sealing layer and the polymer material for the supporting layer are chosen such that the two polymer materials may interact with each other under the molding or bonding conditions such that the sealing layer is retentively attached onto the supporting layer. In preferred embodiments, the sealing layer is made of one or more polymer materials selected from the group of TPE, TPV and PVC, and the supporting layer is made of one or more polymers chosen from the group of polypropylene (PP), polycarbonate (PC), polyvinyl chloride (PVC), acrylonitrile butadiene styrene (ABS), and polystyrene (PS).

In preferred embodiments, the sample tube has a total volume of from about 0.1 ml to about 2.0 ml. In preferred embodiments, all materials used for the sample tube assembly are heat stable and can withstand heat at a temperature of up to 100° C.

Also, in the various aspects and the embodiments thereof, the sealing layer forms one or more annular regions that extend axially for a total length that is at least 10%, 20%, 30%, 40%, 50%, 60%, 70%, 80%, 90%, 100% or 150% of the entire longitudinal length of the substantially cylindrically shaped member of the sealing cap. Preferably, the sealing layer is coextensive with and covers the entire surface of the upper wall section of the vessel body or of the substantially cylindrically shaped member of the sealing cap. Alternatively, the sealing layer may be in a form of an annular convexity covering a portion of the supporting layer but around the entire circumference of the portion, preferably at the lower edge portion of the cylindrically shaped member, or at the upper edge portion of the upper wall section. In some embodiments, there may be two or more coaxial annular rings (e.g., an O-ring) spaced axially apart which are preferably retentively molded onto the supporting layer.

Alternatively, the sealing layer is a continuous layer around the entire circumference of a portion of the upper wall section of a vessel body or the substantially cylindrical member of a sealing cap, while the supporting layer comprises two, three, four, five, or eight or more elongated strips or sections circumferentially spaced apart either on the sealing layer or embedded within the sealing layer, each extending axially along the portion of the upper wall section of the vessel body or the cylindrical member of the sealing cap.

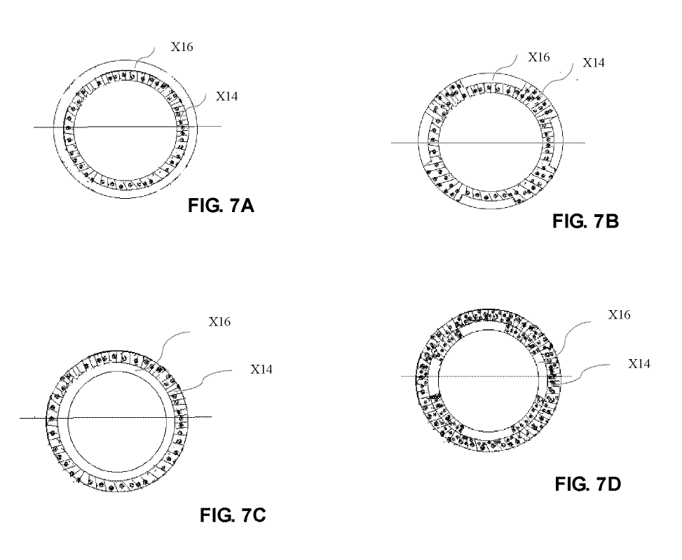

Thus, FIGS. 7A-7D illustrates exemplary constructions of the sealing layer and supporting layer in the various embodiments described above. Specifically, FIGS. 7A-7D are cross-sectional views of a portion of the upper wall section comprising a sealing layer and a supporting layer, or of a portion of the cylindrical member of the sealing cap as in the embodiments described above. In FIGS. 7A and 7C, the sealing layer X14 and supporting layer X16 are both continuous layers around the entire circumference of a portion of the upper wall section of a vessel body or the substantially cylindrical member of a sealing cap. In contrast, in FIGS. 7B and 7D, the sealing layer X14 is a continuous layer around the entire circumference of a portion of the upper wall section of a vessel body or the substantially cylindrical member of a sealing cap. The supporting layer X16 is a supporting layer comprises four elongated strips or sections circumferentially spaced apart in the sealing layer.

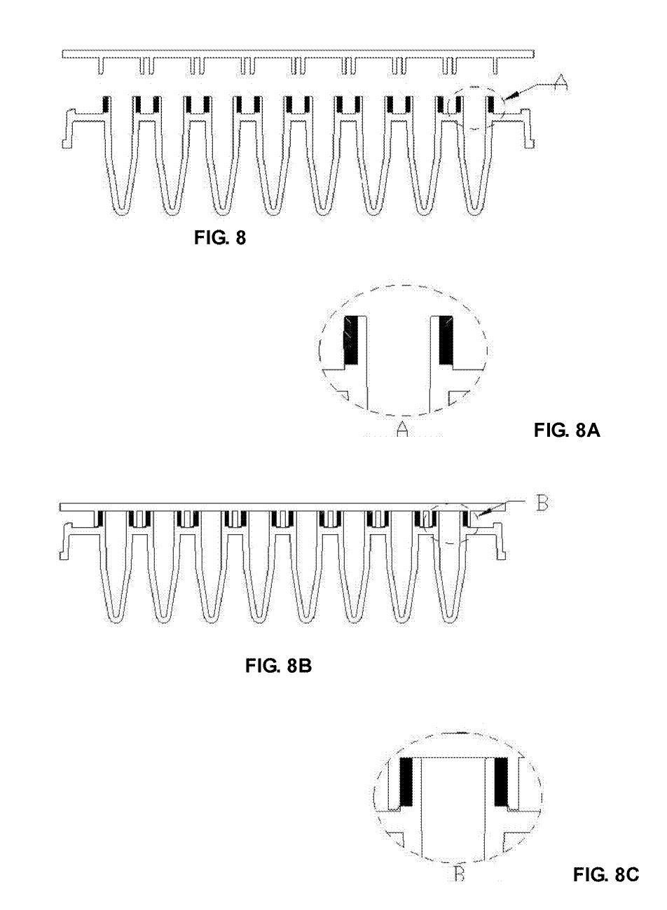

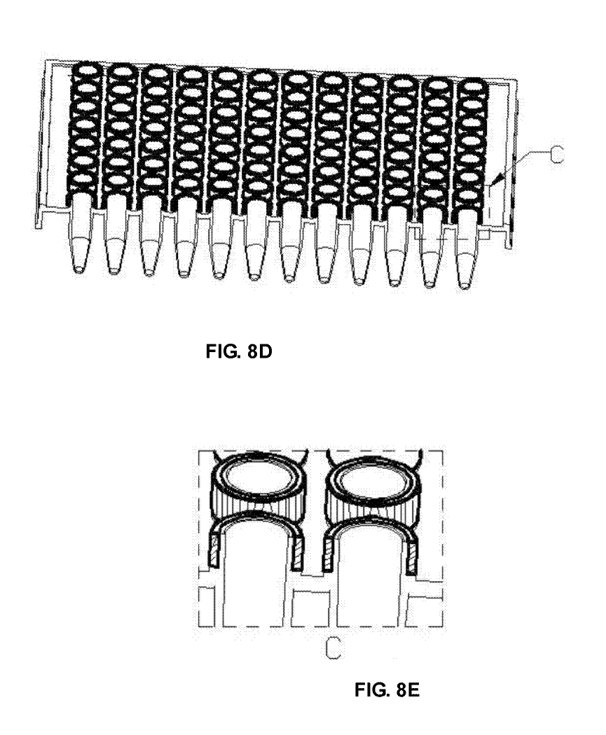

The various embodiments of the sample tube assemblies can be adapted into sample tube strips or multiwell plates, e.g., in industry standard formats, i.e. 36-, 48-, 96-, 192-, 384-well PCR plates. Essentially, in a sample tube strip, a plurality (e.g., 4, 8 or 12) of hollow vessel bodies in one of the embodiments described above may be arranged symmetrically in a linear array whereby their axes are in parallel. The adjacent two of these vessel bodies may optionally be connected through a strip. An exemplary embodiment of a sample tube strip is shown in FIG. 8. In addition, the sample tube strip also comprises a plurality (e.g., 4, 8 or 12) of the corresponding sealing caps in that embodiment arranged in a linear array, and any two adjacent members of the plurality of caps being are connected by a tether. Each of the plurality of caps removably engages the upper wall section of a vessel body. See FIG. 8B. FIG. 8A is an expanded view of section A in FIG. 8, showing the upper wall section of a vessel body comprising an inner supporting layer and an outer sealing layer. FIG. 8C shows an expanded view of section B of FIG. 8B, showing that a sealing cap of is in sealing contact with a vessel body of a sample tube strip.

Similarly, in a multiwell microtiter plate, a plurality (e.g., 36, 48, 96, 192 or 384) of hollow vessel bodies of the same design as in one of the embodiments described above may be arranged in a multiwell plate format, according to standard formats in the industry. The designs and manufacturing methods of microtiter plates are well known in the art, and may be found in e.g., U.S. Pat. Nos. 5,710,381 and 5,475,610, both of which are incorporated herein by reference. For example, a 96-well microtiter plate is a tray with a width of 3⅝ inches and a length of 5 inches and containing 96 identical sample wells in an 8 well by 12 well rectangular array. Thus, each well of the microtiter plate of the present invention has the same design as the vessel body in one of the above embodiments of the sample tube assembly. FIG. 8D shows an illustrative embodiment of a 96-well plate with each well having a design similar to the vessel body shown in FIG. 2A. FIG. 8E is an expanded view of Section C in FIG. 8D. As shown in FIG. 8E, each vessel body has an upper wall section comprising an inner supporting layer and an outer sealing layer. Additionally the plate also includes a plurality (e.g., 4, 8, 12, 96) of the corresponding sealing caps in that same embodiment arranged in an array, and any two adjacent members of the plurality of caps being connected by a tether or sheet. The caps are arranged such that their axes are in parallel. Each of the plurality of sealing caps removably engages the upper wall section of a vessel body.

In preferred embodiments, the supporting layer and the sealing layer should be permanently joined together, which means that they are not easily separable, and the sealing layer cannot be easily removable from the supporting layer. The sample tube assembly of the present invention may be made by conventional processes, e.g., plastic-injection molding or spray-on process. In preferred embodiments, the sealing layer may be directly and retentively molded onto the supporting layer such that the sealing layer can be retained securely on top of the supporting layer. Alternatively, the sealing layer may be adhered to the supporting layer through a bonding material. The sealing layer and the supporting layer may be molded together by a dual component plastic injection molding process. Alternatively, the sample tube assembly is made by a two-step molding: the non-sealing layer parts of the sample tube assembly are first molded, by e.g., plastic injection molding, and then the sealing layer is directly and retentively molded onto the supporting layer.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference. The mere mentioning of the publications and patent applications does not necessarily constitute an admission that they are prior art to the instant application.

Although the foregoing invention has been described in some detail by way of illustration and example for purposes of clarity of understanding, it will be apparent that certain changes and modifications may be practiced within the scope of the appended claims.

What is claimed is:

1. A sample tube comprising:
a hollow vessel body having a substantially cylindrical upper wall section defining at its edge portion the opening of the hollow vessel body; and
a sealing cap having a substantially cylindrically shaped member comprising at least a sealing layer and a supporting layer permanently joined together, wherein said supporting layer has a greater hardness, as measured according to ASTM test D 2240, than the sealing layer, and wherein when said sealing cap engages said hollow vessel body for closing said opening, said sealing layer is in sealing contact with a peripheral surface of said upper wall section.

2. The sample tube of claim 1, wherein said sealing layer is on an outer peripheral surface of said substantially cylindrically shaped member, and wherein when said sealing cap engages said hollow vessel body for closing said opening, said sealing layer is in sealing contact with an inside peripheral surface of said first upper wall section.

3. The sample tube of claim 1, wherein said substantially cylindrically shaped member is skirt-like and said sealing layer is on an inner peripheral surface of said substantially cylindrically shaped member, and wherein when said sealing cap engages said hollow vessel body for closing said opening, said sealing layer is in sealing contact with an outside peripheral surface of said first upper wall section.

4. The sample tube of claim 1, further comprising a flexible strap having opposite ends that are respectively connected with said vessel body and said cap.

5. A sample tube comprising:
a sealing cap having a substantially cylindrically shaped member; and
a hollow vessel body having a substantially cylindrical upper wall section defining at its edge portion the opening of the hollow vessel body, said upper wall section comprising at least a sealing layer and a supporting layer permanently joined together, wherein said supporting layer has a greater hardness, as measured according to ASTM test D 2240, than the sealing layer, and wherein when said sealing cap engages said hollow vessel body for closing said opening, said sealing layer is in sealing contact with said substantially cylindrically shaped member.

6. The sample tube of claim 5, wherein said sealing layer is on an outer peripheral surface of said upper wall section.

7. The sample tube of claim 5, wherein said sealing layer is on an inner peripheral surface of said upper wall section.

8. The sample tube of claim 5, further comprising a flexible strap having opposite ends that are respectively connected with said vessel body and said cap.

9. A sample tube strip, comprising
a plurality of hollow vessel bodies each having a substantially cylindrical upper wall section, arranged symmetrically in a linear array whereby their axes are in parallel, said upper wall section defining at its edge portion the opening of the hollow vessel body; and
a linear array of a plurality of sealing caps each in sealing contact with one of said plurality of vessel bodies, and any two adjacent members of said plurality of sealing caps being connected by a tether,
wherein each of said plurality of sealing caps comprises a substantially cylindrically shaped member comprising at least a sealing layer and a supporting layer permanently joined together, wherein said supporting layer has a greater hardness, as measured according to ASTM test D 2240, than the sealing layer, and wherein said sealing layer is in sealing contact with a peripheral surface of said upper wall section.

10. The sample tube strip of claim 9, wherein said sealing layer is on an outer peripheral surface of said substantially cylindrically shaped member, and wherein when said sealing cap engages said hollow vessel body for closing said opening, said sealing layer is in sealing contact with an inside peripheral surface of said upper wall section.

11. The sample tube strip of claim 9, wherein said substantially cylindrically shaped member is skirt-like and said sealing layer is on an inner peripheral surface of said substantially cylindrically shaped member, and wherein when said sealing cap engages said hollow vessel body for closing said opening, said sealing layer is in sealing contact with an outside peripheral surface of said upper wall section.

12. A sample tube strip, comprising
a plurality of hollow vessel bodies arranged symmetrically in a linear array whereby their axes are in parallel, each having a substantially cylindrical upper wall section defining at its edge portion an opening of the hollow vessel body, said upper wall section having a sidewall comprising at least a sealing layer and a supporting layer permanently joined together, wherein said supporting layer has a greater hardness, as measured according to ASTM test D 2240, than the sealing layer; and
a linear array of a plurality of sealing caps each in sealing contact with the sealing layer of the upper wall section of one of said plurality of hollow vessel bodies.

13. The sample tube strip of claim 12, wherein said sealing layer is on an outer peripheral surface of said upper wall section.

14. The sample tube strip of claim 12, wherein said sealing layer is on an inner peripheral surface of said upper wall section.

15. A multiwell plate assembly comprising:
a plate body having therein a plurality of wells each having an opening, a closed bottom, and a side wall extending therebetween, wherein at least one of said plurality of wells has a substantially cylindrical upper wall section defining at its edge portion said opening; and
a plurality of sealing caps at least one of which having a substantially cylindrically shaped member comprising at least a sealing layer and a supporting layer permanently joined together, said supporting layer having a greater hardness, as measured according to ASTM test D 2240, than said sealing layer, and wherein said sealing layer engages and is in sealing contact with said upper wall section.

16. The multiwell plate assembly of claim 15, wherein said sealing layer is on an outer peripheral surface of said substantially cylindrically shaped member, and is in sealing contact with an inside peripheral surface of said upper wall section.

17. The multiwell plate assembly of claim 15, wherein said substantially cylindrically shaped member is skirt-like, and said sealing layer is on an inner peripheral surface of said substantially cylindrically shaped member, and is in sealing contact with an outside peripheral surface of said upper wall section.

18. A multiwell plate assembly comprising:
a plate body having therein a plurality of wells each having an opening, a closed bottom, and a side wall extending therebetween, wherein at least one of said plurality of wells has a substantially cylindrical upper wall section defining at its edge portion said opening, said upper wall section comprising at least a sealing layer and a supporting layer permanently joined together, wherein said supporting layer has a greater hardness, as measured according to ASTM test D 2240, than the sealing layer; and
a plurality of sealing caps each comprising a substantially cylindrically shaped member, wherein the cylindrically shaped member of at least one of said plurality of sealing caps is in sealing contact with said sealing layer.

19. The multiwell plate assembly of claim 18, wherein said sealing layer is on an outer peripheral surface of said upper wall section.

20. The multiwell plate assembly of claim 18, wherein said sealing layer is on an inner peripheral surface of said upper wall section.
